(19) United States
(12) Patent Application Publication
(10) Pub. No.: US 2003/0097541 A1
(43) Pub. Date: May 22, 2003

(54) Latency tolerant processing equipment

(76) Inventors: Igor Anatolievich Abrosimov, St. Petersburg (RU); Alexander Roger Deas, Edinburgh (GB)

Correspondence Address: Igor Abrosimov, Office 501, 58 Moika Embankment, St. Petersburg, 190000, RU

(21) Appl. No.: 10/298,047

(22) Filed: Nov. 18, 2002

Related U.S. Application Data
(60) Provisional application No. 60/331,517, filed on Nov. 19, 2001.

(51) Int. Cl. G06F 15/76; G06F 15/00

(52) U.S. Cl. 712/1

(57) ABSTRACT

A processing architecture for performing a plurality of tasks comprises a conveyor of pipe stages, having a certain width comprising different fields including commands and operands, and a clock signal; wherein each pipe stage performs a certain part of an operation for each task of the plurality in a respective time slot.

The processing architecture is also implemented in random access memory and dynamic random access memory devices.

The present invention provides processing of data such that latency of memory and communication channels does not reduce the performance of the processor.

### BACKGROUND OF THE INVENTION

1. Technical Field

The present invention relates to methods and apparatus for processing data. More particularly, the present invention concerns methods and apparatus for processing data such that latency of memory and communication channels does not reduce the performance of the processor.

2. Background of the Invention

Most computers in use today are based on a Von Neuman architecture, or a Harvard architecture. These computers operate by an instruction being fetched from memory, the instruction being decoded and applied to fetch the data. This data is then operated on within a datapath—the instruction decode determines the path of the data through the datapath, usually from memory or an accumulator, through an arithmetic logic unit (ALU) into another accumulator or memory. The performance of this process depends very heavily on data being available within a single clock cycle from memory, and the processing degrades when this is not the case. Modern datapaths involve delays or pipeline stages which may be many clock cycles in length: for example, data from an accumulator is applied to a bus in one cycle, read into a register in an ALU in a second cycle or on a second edge, then on a third cycle the output of the ALU is latched, and so on. Accessing external memory, such as in a cache miss, typically causes delays of more than 100 clock cycles due to the combined latency of the pipelined logic in the processor, the latency of the communication channel and the access time of the memory.

To reduce these delays, various approaches have been adopted. Fast cache memories are used, often on the same die as the processor, to minimise the turnaround. This approach is very expensive in silicon area and the benefits depend on particular program characteristics, which may or may not be present. The datapath, instruction fetch and decode, data fetch are all heavily pipelined, such that the instructions and possible data operands all arrive in synchronism. To facilitate execution of instructions, multithread structure, such as in U.S. Pat. No. 6,463,526 is used wherein each speculative thread executes instruction in advance of preceding threads in the series. Such pipelining is necessary to achieve high operating frequencies but if the result of a computation from one cycle is used in next cycle then it always causes the waste of the whole pipe conveyer as further results becomes undetermined until the pipe turnaround is complete. Another problem, which caused by pipelines, is that typically every 10 macro instructions (for a C program), cause a conditional branch and this disrupts the flow of the pipe as well.

A highly parallel processing structure is disclosed in U.S. 2001/0042187 for executing a plurality of instructions mutually independently in a plurality of independent execution threads. To increase the system clock rate, it is desirable to implement even heavier pipelining than is used presently because pipelining allows complex logic functions to be split into simpler fractions separated by flip-flops with a reduced clock period, which is sum of the flip-flop clock to output time, logic propagation time and the setup time for the next flip-flop.

There are many approaches described in the prior art to look ahead effectively and evaluate a branch to try and reduce this problem, but the problem is intrinsic to all computers. Another approach to the branch problem is to waste hardware resources evaluating possible outcomes of a branch, despite the fact that one of these outcomes will be used.

Taking parallelism to an extreme, systolic architectures break a task into many threads, each of which is similar, and pipe all of this, but at the core of these systolic arrays there are processors which have the same latency issues as for the single processor, but to a higher degree as more cycles are used in the pipe of data.

Zero cycle task switching has been proposed as a means by which processors, such as network processors, can run multiple tasks on the same data set. This means that a processor has several data sets loaded into it, and when a latency delay will cause a pause in the processing of this data, then the processor switches to another task, such as a thread switch logic disclosed in U.S. 2002/0078122. This approach is useful at lower speeds, but at the highest clock rates, there are many pipe stages throughout the control logic, datapath, instruction decode, and other operations intrinsic to the processor which makes it impossible to define in advance will it require task switching or not.

For example, in the Intel Itanium processor (IA64), a very large part of the die area is dedicated to perform speculative precomputation and in the case of branch operations or wait cycles caused by cache missing penalties, the processor switches to another thread, such as described in U.S. Pat. No. 6,247,121. This approach involves complicated logic which is expensive in silicon area, yet still has a significant rate of wrong predictions and performance penalties caused by memory latency. Moreover, it creates a high demand for cache memory which is shared between threads and requires a huge number of internal registers to allow most of variables involved into calculations to be kept in registers inside the processor: for example in the Intel Itanium processor, they use 128 integer registers, 128 floating point registers, 64 predicate registers and numerous others, in addition to more than 3 MB of fast cache. The main objective of this type of architecture is to speed up a single thread application by the possible utilisation of cycles when the main thread can not be processed due to the non-availability of data or operational units. However this type of system still is highly sensitive to the size of caches, amount of data processed, internal and external latency, and significantly depends on type of application program that is executed. A large amount of data processed in real time high speed streams significantly degrades performance.

Another approach is used in Alpha 21464 processor which can change the order of independent commands if the first command can not be performed due to sub blocks being occupied by the previous command, then a second command in the queue of commands can be performed on a non-loaded piece of hardware in the same cycle by the processor unit. The main goal of this approach is to minimise the number of wasted cycles by manipulating the instruction order, rather than significantly increase operating frequency and number of instructions performed at the same time. This approach requires complicated control logic which can not operate at the maximum flip-flop toggle rate. The present invention require much simpler logic and can operate at the maximum flip-flop toggle rate, which is normally much faster than the clock speed of modern processors.

A high sensitivity to latency restricts internal logic being split into different pipeline stages, and this can mean that a processor operates at 800 MHz—this is the maximum announced by Intel as of the filing date for the Itanium IA64 family, instead of about 8 GHz which is the speed of the same hardware if it were to embody the present invention. This sensitivity to latency also prevents processors being split onto several smaller chips. The present invention overcomes these restrictions.

### BRIEF SUMMARY OF THE INVENTION

It is an object of the present invention to increase the hardware utilisation such that more processing is performed by a given amount of hardware than in the prior art.

It is another object of the invention to provide a processor element which may be coupled with other processor elements to form an efficient and programmable processing system which is highly tolerant, or even intolerant of latency of data both that moving within the processor and outside the processor, such as from processor to main memory.

Still another object of the invention is to provide methods for transferring and collecting data communicated between processor elements and external memory in a digital data processing system, such that the processing elements are fully utilised.

Still another object of the present invention is to eliminate the cache memories, which require a large silicon area, without degrading the processor performance.

Still another object of the present invention is to increase the overall speed at which a composite task is processed, such as executing all the layers of a network protocol, graphics processing, workstation processing or digital signal processing tasks.

Still another object of the present invention is to reduce the energy required by processor element per operation.

The present invention in its most general aspect is a processing architecture which assigns a time slot to each task, such that the total number of tasks being processed is preferably equal to or exceeds the longest latency within the system, each time slot being a pipe stage, and then balance the pipe depth of each of these routes.

Thus, in one aspect of the invention, a processing system is provided for performing a plurality of tasks comprising at least one task, each task comprising a sequence of operations, the system comprising a conveyor of pipe stages, the conveyor having certain width comprising different fields including commands and operands, wherein each pipe stage is assigned a time slot for performing each task of the plurality, and each pipe stage performs a part of an operation for each task of the plurality in the respective time slot.

Preferably, the total number of tasks being processed exceeds the longest latency within the system. A pipeline can be used for equalizing the latency between different pipe stages.

The number of pipe stages in the respective fields of the conveyor width can be increased so that the number of pipe stages on each field of the conveyor is the same.

The datapath, the accumulators, the memory and the control logic are considered as a conveyor. At every clock period, a plurality of parallel actions are carried out, one action by each stage of the conveyor. On each clock cycle, each task flows from one stage to the next stage, through the various data processing and storage functions within the processor. The total amount of processing carried out is the number of conveyor stages, and this is determined by the amount of pipelining within the processor—this ideally being equal to the maximum latency of any function. The conveyor includes the instruction fetch, instruction decode, data fetch, data flow within the data path, data processing, and storage of results.

In an extreme case, according to one of the possible embodiments, the processor according to the present invention can operate without any internal registers or accumulators, keeping all processed data in the memory. In this case, the processor comprises just a memory and pure processing or instruction management functions. This can reduce very significantly the amount of silicon needed to implement any multi-thread processor.

Such type of processors can be split onto plurality of separate chips without performance degrading and thus providing cost effective solutions.

The implementation of such type of computing systems requires high speed synchronous busses to transfer data on each segment of the conveyer at the same rate. That is, the pipelines of each of the main units are synchronised. Such type of interfaces can be implemented using technology described in U.S. Pat. No. 6,298,465, PCT/RU00/00188, PCT/RU01/00202, U.S. 60/310,299, U.S. 60/317,216 filed in the name of applicants of the present application.

To illustrate the concept of the present invention, without loss of generality, an example will be considered now how a computing system wherein each instruction is performed in one clock cycle may be speed up by an order of magnitude with reducing energy required to perform each operation. The clock rate for this computing system is limited by time interval required to pass data from instruction pointer through instruction memory to instruction decoder, then through selecting operands circuitry through ALU and then through storing results circuitry. The aggregate of all internal registers, such as Instruction pointer or Accumulator, comprises current State of this state machine determined by logical function which converts current State into the next State.

To speed up this system according to the invention, a flip-flop is placed at the output of each logical gate of this logical function implementing as many pipeline stages as required. Obviously, all branches of implemented logical functions shall be kept at the same latency when applied to the next logical element in the pipe and simple pipeline for equalizing latency can be required at some stages. The energy dissipation with one extra flip-flop on the output of this logical gate will be increased by 2-3 times depending on the number of loads on this logic gate, while overall performance can be increased 10 times or higher reducing average amount of energy required per operation by several times.

The propagation delay through a single logical gate can be many times smaller than original function allowing clock rate for state machine with split and separated by flip-flops logic to be many times higher than in original case. For example, typical propagation delays for 4 inputs logical gate at 0.13 u CMOS process can be as small as 40 ps. In fact, this means that logic delays become smaller than minimum clock period required by flip-flop and the maximum operating frequency becomes automatically equal to the maximum toggle rate of used flip-flops independently from the complexity of performed operations. For example, it is possible to achieve up to 10 GHz operating frequency with dynamic flip-flops and 0.13 u standard CMOS process.

It shall be mentioned that, in case of performing single task, such pipelining does not make any speed advantages except special cases with vector or matrix arithmetic operations because turnaround time through all stages will not be smaller than for all logic combined at one stage. In case of multiple tasks, whole entire logic can be efficiently shared between different tasks due to synchronous circulating through pipeline stages to perform during almost the same period of time one operation on each task instead of one operation in a single task. This approach keeps all mechanism free from any performance penalties caused by any combinations of operands or operations and does not require any additional resources to perform tasks switching.

In particular case, the processing apparatus can be split onto 32 pipeline stages including pipeline in the memory and can be arranged to execute 32 processes simultaneously, so that during the first clock period first pipe stage executes first part of an operation from task N, the second pipe stage in the processor executes the second part of an operation from task N−1, and so on. During the next clock period first pipe stage executes first part of an operation from task N+1, the second pipe stage executes second part of an operation from task N, and so on. All tasks are circulating across this pipeline system synchronously.

Advantageously, to keep a system free from any wait cycles and any loss of performance, the amount of tasks to be processed shall be not less than the amount of pipeline stages in the loop.

Another requirement is to have data rate on each segment of this loop not less than system clock. Particularly, this means that it requires memory to operate at system frequency performing different operations with different addresses on each clock cycle. This can be achieved by extra pipeline latency in the memory chip without affecting overall system performance.

In other way, the processor can use separate memory chips or banks inside the same chip such as in SDRAM chips, with total amount of memory chips or banks not less than maximum memory operation period divided by system clock period allowing to interleave memory chips serving different tasks by different memory chips or banks.

Processor core can be easily split between separate dies with increased overall latency and so with more tasks performed in parallel. This allows to replace one big die by several smaller dies without affect to overall system performance.

As a result of utilizing this architecture, the system can increase performance by more than 10 times with only about 2-3 times more silicon required and with only 2-3 times higher power dissipation, which reduces energy required per operation and cost of silicon per performance by factor of 3-5. In equivalent this type of system performs on each clock cycle one instruction with any type of complexity like performs several operations in parallel in the same cycle as used in modern DSP.

By removing the need to minimise the latency within the system, much more efficient means to maximise the amount of processing becomes feasible. For example, a parallel divider requires number of logical gates between input and output proportional to processed data width. Bigger data width causes lower operating frequencies for this unit. With described here approach it can use extra pipeline stages between each logical stage allowing to operate at highest possible frequency independent from data width. This is true of many processor functions, such as floating point units, barrel shifters, cross point switches and other hardware. The same level of performance is usually achievable with special conveyer processors only specialized for performing very limited number of algorithms with vectors and matrixes but significantly loosing performance on random instructions flow where result of previous operation frequently used on the next operation or branches depends on the result of previous operation. According to approach described in the present application, all tasks are completely independent from each other and each of them can be completely free from any overhead caused by overall system latency.

Especially, this is applicable to many computational systems in which several processes are to be executed at once. For these purposes, conventionally, special mother boards are designed that comprises several processors to increase the performance of the system in whole. An example of these systems is processors produced by Sun Microsystems Inc, or SPARC processor. Another application the present invention is well suited, is to network processors, which must apply a series of tasks on the same data. For example, a network processor may apply framing or parsing of the stream, classification, various data modification steps, forwarding, prioritising, shaping, queuing, error coding, encryption, routing, billing or flow management. Each of these tasks run in parallel, and have the same or proportionate volumes of data flowing through them.

Another application where present invention is widely applicable is digital processing systems which perform signals analysis on several-streams of data in parallel. For example, pipelining all structures in the same core allows to have multiple processors in the single chip operating at the same speed as the original processor.

According to one more aspect of the invention, a random access memory device is proposed comprising a plurality of pipe stages forming a conveyor and logics for implementing address decorders, data selectors, and fan-outs of signals within the memory, wherein the conveyor is synchronised by a clock signal, wherein the amount of logics is selected to exclude affecting the conveyor clock rate.

Preferably, in such a random access memory device, the amount of logic is minimised by adding as many pipe stages as required to keep the amount of logic between two stages such that a signal propagation time is maintained across the logic to be less than the cycle period minus setup/hold time for each stage minus clock-to-output delay for the previous stage and minus interconnect delays between this logic and the surrounding pipe stages, thereby the clock period for the conveyor is minimised.

In still another aspect, a dynamic random access memory device for storing data is provided, comprising a plurality of memory banks for serving different tasks to provide a conveyor processing of operations from different tasks.

These inventions will be described further in detail.

### BRIEF DESCRIPTION OF THE SEVERAL VIEWS OF THE DRAWINGS

These and another aspects of the present invention will now be described in detail with reference to example embodiments of the invention and accompanying drawings which, however, should not be taken to limit the invention to the specific embodiments described, but are for explanation and understanding only.

FIG. 1 illustrates a conventional data processing system as a state machine implementation.

FIG. 2 shows a processor architecture according to the present invention with additional register or storage stages within the processor core path (datapath and control);

FIG. 3 shows a memory organised according to the present invention to have a very high bandwidth with a large latency.

FIG. 4 shows a dynamic flow of signals through a memory shown in FIG. 3.

### DETAILED DESCRIPTION OF THE INVENTION

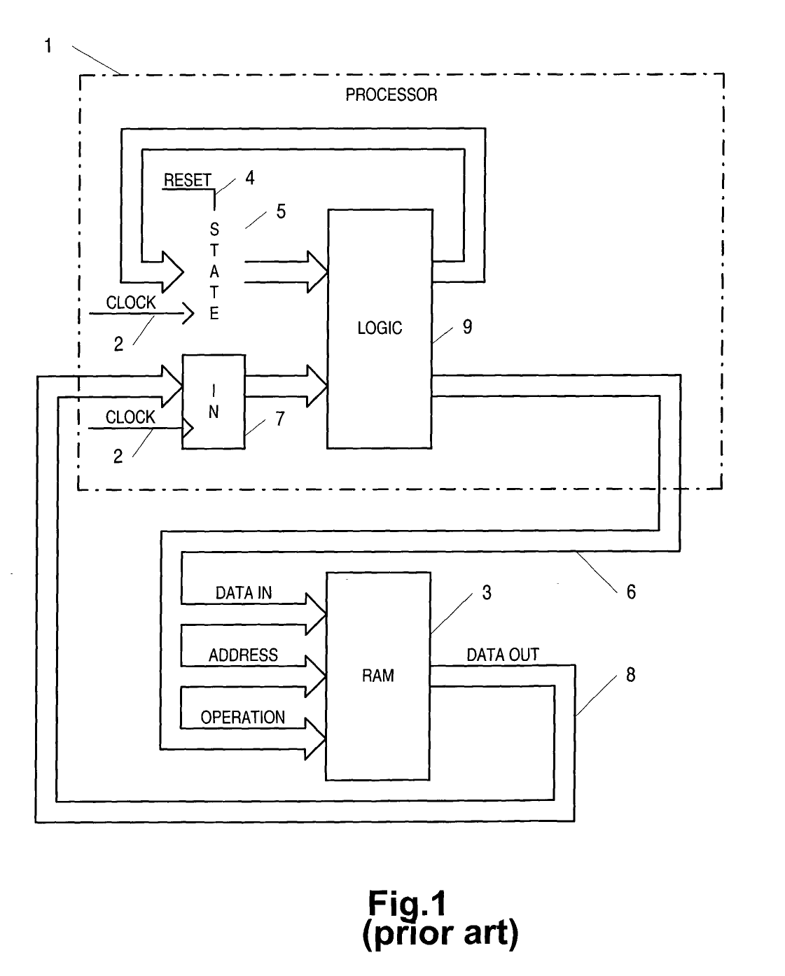

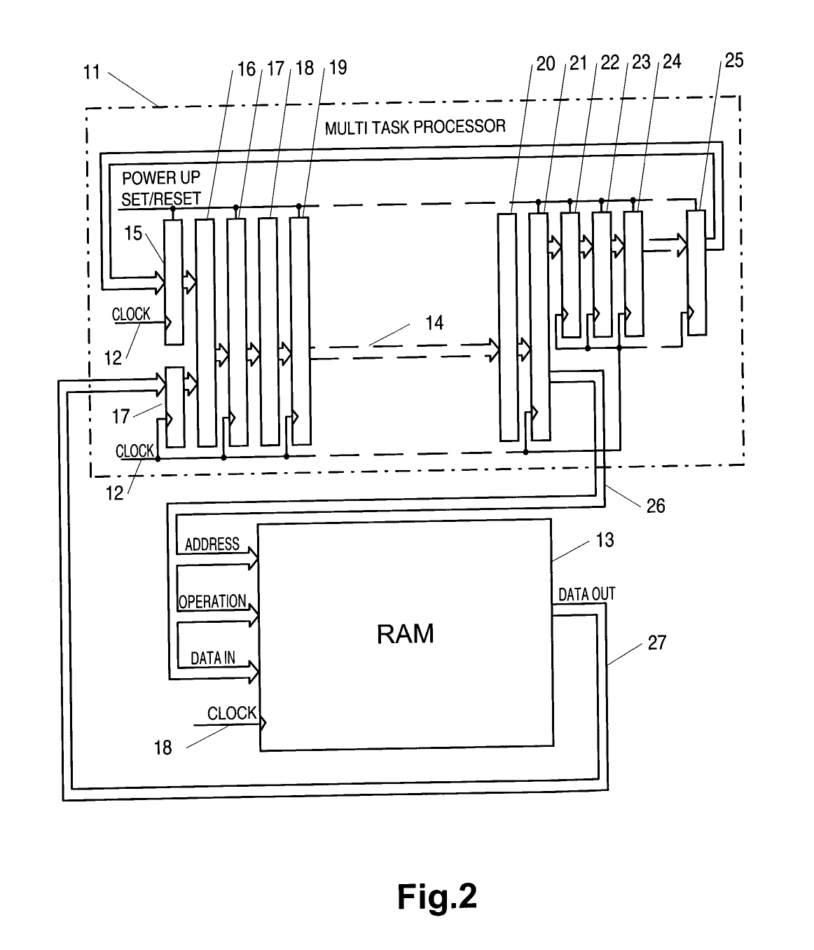

The best way to understand the present invention is by comparison with a conventional approach. The present invention as shown in FIG. 2, and the prior art processor in FIG. 1, will be used for the purpose of this comparison. For the logical development of the description of the present invention and by way of background, it is appropriate to describe a contemporary processor, such as in FIG. 1, first.

Any processor can be described as a state machine. A typical prior art processor, such as shown in FIG. 1, comprises a memory 3 for storing data and program, a set 5 of registers for storing the current state of processor 1, a set of registers 7 for loading input data and a control logic device 9 for determining output signals 6 and new state of processor to be loaded into state register 5 on the next cycle of clock 2 Inputs and outputs are assumed to be part of the memory address, and not shown.

The processor in FIG. 1 operates as follows. On initialisation from a reset line 4, addresses are generated from the processor logic 9 which fetches data 8 from memory 3; the data is fed back through the processor logic 9 to determine the state of the logic in state registers 5 that are usually spread throughout the processor in the form of accumulators, program counters, buffer registers, pre-charged or dynamic storage or bus elements and registers holding the value of pointers. The set of state registers 5 along with the program determines the order and value in which addresses are generated, and the data that is written to memory 3 via operations generated by the control logic 9.

The normal sequence of operations is that, after power up, the processor system reset 4 loads a start address into a program counter, the contents of the memory 3 are fetched, this being an instruction with data operands that normally represent pointers to where the main program resides. Any combination of commands may be in the program, to store data from memory 3 to registers 5 in the processor, or from the registers to the memory, or sequence control instructions such as evaluate and branch instructions.

For example, if the processor fetches an instruction to move data from a memory location M(k) to an internal register r, where k and r are data operands of this instruction, then the control logic 9 first decodes the instruction, then applies the addresses of the memory location m through the logic onto the address bus with appropriate memory read operations, reads the data on the next clock cycle, through the input register 7, takes the data operand field of the instruction through the logic 9 and writes the content to the internal register n, by appropriate manipulation of the internal control bus which is a part of the processor logic 9.

This is a pipe of operations, which only flows smoothly if all components operate within one clock cycle. Whilst this can be true in very slow or simple systems, generally, at high speed this inevitably would cause wasting hardware resources, i.e. that hardware that is able to process data or instructions but cannot because a previous stage has more than one clock cycle of latency and the address was not able to be forecast—even forecasting requires extra hardware that is not involved in data processing.

In FIG. 2, a processor is shown according to the invention, that runs the same instructions, but comprises extra stages comparing to the prior art processor shown in FIG. 1. Both processors have a respective set of state registers (5 in FIG. 1, and 15 in FIG. 2) with the same meaning, both have a memory (3 in FIG. 1 and 13 in FIG. 2, in which the more realistic case is shown when the memory has a latency of a number of clock cycles), both are controlled via a clock (2 and 12), respectively, both have an input register (7 and 17) performing the same task.

The differences lay in the construction of the core logic with extra pipeline stages, which allows the logic to be split into small fractions.

In the diagram of FIG. 2, no distinction is made between the datapath and the control logic path because in reality the flow through these must be synchronous and they can be considered as combined, even though in their implementation very different methods are used.

The processor 11 comprises two parts, the first one being processor logic and data operations 16 to 19, which perform the same logic function as unit 9 in FIG. 1, but with extra pipeline granularity to allow a higher speed system clock by reducing the propagation time from one stage to another, and the second comprising auxiliary registers 20 to 25 to match the total turnaround time of the overall pipe with the latency of the memory. The number of registers in the match pipe 20 to 25 can even be regulated to accommodate various configurations of external memory high speed subsystem 13 and other components.

For a better understanding of the present invention, the system in FIG. 2 can be compared to a watch, with different sets of gears each running from a clock (a spiral balance or hairspring in the case of a watch), which sets a strobe from which different gear mechanisms are derived. The external operations have one speed, as a gear each with many cogs. Each of these cogs are a different task in the present invention, and each time the gearwheel rotates 360 degrees, all of the cogs are exercised. Internal processes may circulate within the processor logic, but have the effect of issuing data or instruction fetch or write operations to the memory at the exact time their slot, or cog, for that task is presented to the processor logic.

Each pipe stage of the processor logic is running a different task, so as these are clocked, the conveyor of tasks progresses. On each complete loop of the conveyor, each task may have one external memory operation. This is possible, and desirable, when the duration of each pipe stage is very short. However, it is almost the opposite in dynamic terms in the conventional processor, i.e. the processor in FIG. 1 needs a slow clock speed for everything to progress on a single cycle per pipe, and for the size of each of the pipe stages to be long, as the access time of the memory is long. In contrast, the present invention requires a fast clock to progress data rapidly, as the time to execute a single task is close to the time for the conventional processor, but it is executing n tasks in this process both synchronously and simultaneously, where n is the total pipe turnaround.

The data to register move operation that has been considered earlier for the conventional processor according to FIG. 1, will be discussed now with reference to the present invention.

After power up reset, the fields which represent the program counters for each pipeline stage in the multi-task processor 11 according to the invention, as shown in FIG. 2, are filled with unique start addresses. There is one program counter register per task, and we run n tasks, and this program counter forms part of the state register 15 for task 1 and corresponding fields of further pipeline stages for tasks from 2 to n. During operation processing, this field passes through the logic on a pipe and generates a new instruction and data address (PC address) for this particular task, in n clock cycles. The value of the access time of the external memory in clock cycles should not exceed n minus number of clock cycles required by processor core to perform operation. The value of n could be bigger, but at the cost of extra internal registers.

During power up reset other than program counters, field could be initialized according to No Operation (NOP) instruction.

The address of new instruction will go through the processor core logic withoutchange as NOP performed and after processor core latency, which is n minus memory latency clock cycles, this address will appear on the memory address input. After memory latency amount of clock cycles, code and operands of first instruction will appear on the input of the processor. Decoding instruction in pipelined core logic processor will pass operand k to the memory address input after processor core logic latency amount of clock cycles.

If first instruction will require to move data from a memory location M(k) to a register r, where k and r are data operands of the instruction, then data operand field with k will be passed by core logic to the memory 13 address input accompanied by code of Read operation on the memory 13 operation input decoded from the instruction after processor core latency amount of clock cycles. After memory latency, the data will be passed to the processor. The field of instruction with type of operation and address of destination will circulate across core logic-and will be loaded into the status register 15 in n clock cycles. At the same phase, data from the memory location k will be loaded into the processor.

During second circle of the operation, data from the memory will pass to the field of status corresponding to the register r and will be loaded into this field after n clock cycles. Next instruction can be fetched from the memory while data are moved to the register r.

Thus, instead of 2 clock cycles processing of such operation with processor presented in FIG. 1, the processor according to the invention as shown in FIG. 2 will complete this operation in 2n clock cycles. During the same time it will perform one operation on each task, so overall performance or number of operations performed in a time unit will be the same. However, there is no any extra NOP cycles or WAIT states required caused by system or memory latency. This allows to increase operating frequency of the processor without any overhead in performance by splitting core logic onto number of pipeline stages required to operate at maximum flip-flop toggle rate.

When we refer to a register, this can be a static register, or preferably, includes dynamic structures such as pre-charged structures, and dynamic logical gates such as flip flops without a feedback loop with logic operations implemented on each half of the flip flop.

To allow processor to operate at such high frequency, the system requires memory 13 to perform one read or write operation per clock cycle with independent order of addresses or operations, i.e. without any data burst functions.

This can be done with the same approach by inserting required pipeline stages into the memory core to increase operation frequency by increasing memory latency.

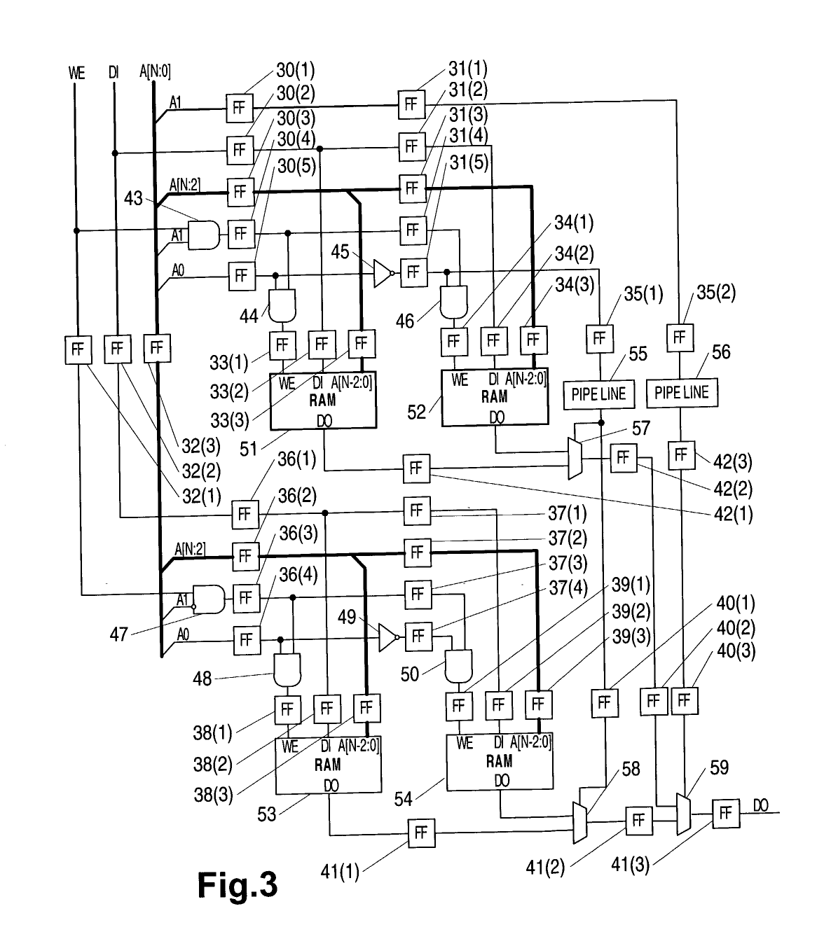

The way to implement such pipelined address decoder is shown in FIG. 3.

Circuitry has inputs for write enable WE, DATA IN DI, Addresses A[N:0] and DATA OUT DO. Circuitry is highly pipelined with limited to 1 amount of logic gates between flip-flops and limited number of loads connected to the output of each logic gate or flip-flop. These ensure that circuitry can operate at maximum flip-flop toggle rate with up to 10 GHz at 0.18 u standard CMOS process using dynamic logic gates.

The circuitry consists of conveyer stages implemented by several sets of flip-flops 30-42 and pipelines 55-56 for providing required latency, logic gates 43-50 to decode 2 address lines A[1:0] to select one of memory banks 51-54, multiplexers 57-59 to pass data to the output from one of memory banks 51-54 selected by addresses [1:0]. All flip-flops, pipelines and memory banks are connected to the same clock signal, which is not shown on FIG. 3 for simplicity.

Pipelines 55 and 56 shall have the same number of stages as latency in each of memory banks 51-54 for proper synchronization. Each of memory banks 51-54 has the same inputs and output as the circuitry described on FIG. 3, but with reduced amount of addresses by 2 bits. Each of memory banks 51-54 can be implemented by the same approach with internal memory banks implemented in the same way and so on up to the bottom where amount of addresses will be reduced to 0.

These lowest level memory bank can be implemented by simple flip-flop with clock enable connected to WE input, data input connected to DI input and flip-flop output connected to DO. It is obvious that whole circuitry is constructed according to high speed requirements to have one simple logic gate between flip-flops and has only 1-3 loads on the output of each flip-flop. Thus whole memory structure is described by FIG. 3 recursively. This can be reviewed backwards. The smaller is the size of the memory, the higher is the clock rate at which it can operate.

According to the approach as disclosed in the present invention and illustrated in FIG. 3, the memory size can be increased without reducing operating frequency. It could be possible to start from small memory structure rather than single flip-flop to provide a tradeoff between speed and silicon size.

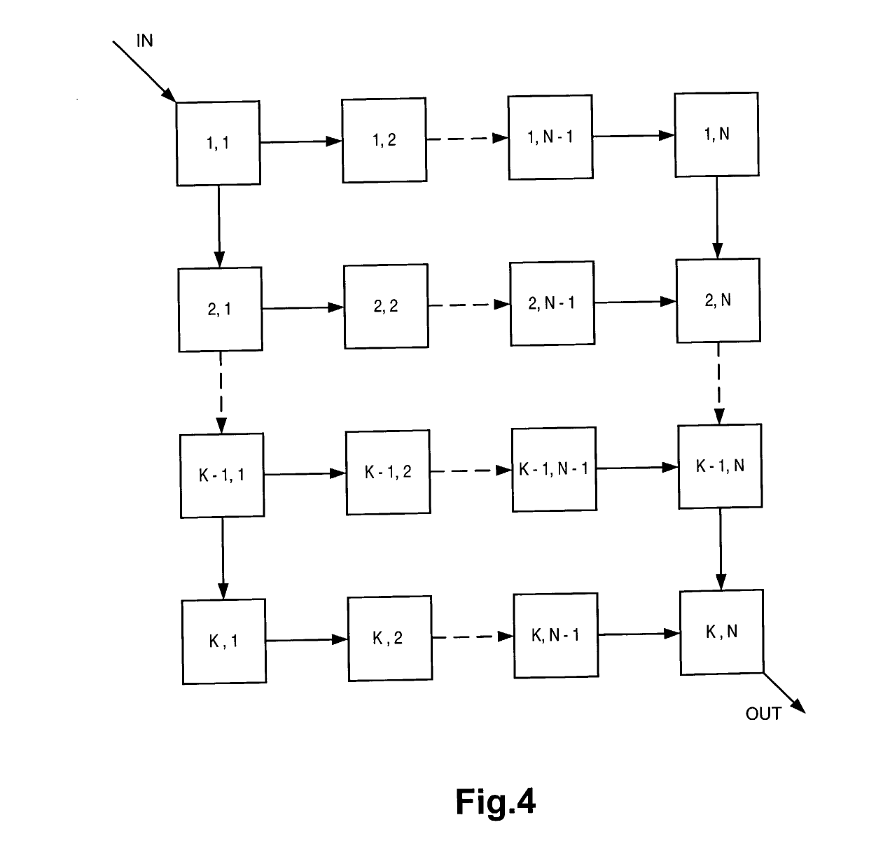

FIG. 4 illustrates operation of this circuitry in dynamics. The whole area of memory is split onto N×K memory sub blocks. On the particular example shown on FIG. 3 memory is split onto 2×2 blocks. On each clock cycle, output and input signals goes through one conveyer stage from one block to another in a direction shown by arrows. On each column except the first one, each block passes to the block output data from the memory incorporated in this block or data received from other blocks depending on control signals decoded from address. The latency of this memory structure is independent from the memory sub block accessed as number of stages from the input IN to the output OUT is the same for all possible paths.

According to the example embodiment of circuitry shown in FIG. 3, on the first clock cycle, Address, Write Enable and Input Data are applied to the inputs WE, DI and A. Logic gate 43 is used as a part of address decoder and disables write into memory blocks 51 and 52 if A1=0.

On the second clock cycle, flip-flops 30(1)-30(5) and 32(1)-32(3) load these new values, and next address, data and operation are applied to the inputs WE, DI and A. From the outputs of flip-flops 30(1)-30(5) address, data and masked by address write enable signals pass to next pipeline stage formed by flip-flops 31(1)-31(5) and for address decoding elements 44 and 45.

At the same clock cycle, the same information is applied to the pipeline stage formed by flip-flops 36(1)-36(4) involving extra address decoder logic gate 47 which disables write operations into memory blocks 53 or 54 if A1=1.

Thus, A1 selects a row of memory blocks which will be accessed.

For A1=0 it accesses bottom row with memory blocks 53 and 54.

For A1=1 it accesses top row with memory blocks 51 and 52. Logic gates 44-46 decode one of memory blocks in a row from address line A0.

Thus, for A0=0 it accesses memory block 51 and for A0=1 it accesses memory block 52.

Similar function is performed on the second row by logic gates 48-50. So, for A0=0 it accesses second column with memory blocks 52 and 54 while for A0=1 it accesses first column with memory blocks 51 and 53.

On third clock cycle, address, data and write enable are applied to the inputs of memory block 51 and pipeline stage formed by flip-flops 37(1)-37(4) and 34( )-34(3).

On fourth clock cycle, memory block 51 loads these signals and will provide on its output data from addressed memory location after M memory block latency amount of clock cycles. At the same clock cycle address and decoded write enables will appear on the inputs of memory blocks 52-53 and pipeline stage formed by flip-flops 42(1), 37(1)-37(3) and pipelines 55-56.

On fifth clock cycle, memory blocks 52-53 loads address, data and write enable signals and starts processing that operation. At the same clock cycle signals applied to the input of memory block 54.

On sixth clock cycle, memory block 54 starts to perform operation. Then, operations will be processed by memory blocks 51, 52-53 and 54 with 0, 1 and 2 clocks shift correspondingly. In case of write operation, only one of memory blocks will have write enabled due to address decoder. In case of read operation all 4 blocks performs it in parallel.

For improved power consumption, more complicated address decoders can be used with extra clock enable function on flip-flops to prevent from address propagation onto not selected block to reduce amount of toggling gates and so energy required.

On M+3 clock cycle data from memory block 51 appears on its output.

On M+4 clock cycle data appears on the output of flip-flop 42(1) and memory blocks 52-53 and delayed A0 and A1 appear on the output of pipelines 55 and 56 respectively. Muxer 57 selects which of bits will be passed to flip-flop 42(2). For address A0=0 it passes data from memory block 52 and for A0=1 it passes data from flip-flop 42(1). On the same clock cycle data from memory block 53 are loaded into flip-flop 41(1).

On M+5 clock cycle, multiplexer 58 passes data according to the value of A0 from memory block 54 or flip-flop 59 in similar way.

On M+6 clock cycle data appears on output of multiplexer 59 and depending on the value of address A1 data will be passed from first or second row through appropriate flip-flops.

Finally, on next clock cycle, data will appear on the output DO. Overall latency of this example is M+6 or 3 per address bit. Thus, if a single cell without addresses will be a single flip-flop, then for memory with 20 address lines overall latency will be 60 clock cycles.

One of the advantages of this approach is that write operation can be performed simultaneously with read operation into the same memory location providing possibility of performing tasks synchronization through gating mechanism without any “Bus Lock” functions required in conventional approach. Similar approach can be used to build multi port memories with plurality of independent read and write ports.

Other ways to build memory without degrading in speed can be implemented by using proper pipeline stages.

For example, comparatively slow but very cheap DRAM core can be used if memory is split onto multiple banks which are assigned to different tasks and will not receive commands from other tasks. In this case even slow core can be used very efficiently. If number of DRAM banks is equal to number of tasks and each DRAM bank is assigned to different tasks there is no need to use bank address and they can be rotated synchronously with tasks circulating provide each task with individual, low cost, unshared memory space with the same addresses for local task variables. Both shared and unshared memories can be combined in one system.

To control multi task processor with big number of tasks, several methods can be used with different benefits depending on the type of applications. For the applications where computing system is processing fast flow of queries, such as network processors, transacting systems, database servers, graphic cards or DSP applications processing multiple channels in real time, the system has lower number of tasks than quires and so can operate at maximum speed assigning one input query to one internal task. This requires to load different values during power up initialization into the field responsible for instruction address in all pipeline stages. This will cause all tasks to start from different addresses and perform independent from each other command flow.

The same way can be used when all computing system is implemented on a single chip or is a part of more complicated system. For example, it is possible to take Alpha 21464 processor or similar and split all internal state machines onto several stages implementing several copies of this processor running in parallel and considering pipeline conveyer going through cache memory only and leaving further performance optimization for their own methods, such as changing order of commands in a task or running several tasks in each copy of this processor simultaneously increasing total number of tasks running at the same silicon at the same speed by several times.

In addition to this, due to pipeline length tolerance, it allows to convert all different layers of internal cache to operate at the same full speed as whole processor logic with virtually 0 cycle access time to large cache with multiple ways for performing 3-4 operations in the same cycle with operation fetching for one task, one or two operands fetching for another task and saving result from another task. This topology will be closer to Super Harvard Architecture and could be more suitable for this application.

For other applications where number of tasks can be less than number of queries to allow higher level of parallelism it requires more intelligent tasks control. For example, processor can support instructions which starts new tasks by a single command returning task identifier and another command to wait until task identified by the identifier is compete. When current task starts new task and there is no unused task available, then processor can postpone current task and continue with new one. When any task complete it can continue postponed task. For example simple “for” cycle statement can be implemented by performing the same loop with starting tasks with body on each cycle and then wait until all of them will be finished. This will allow to perform thousands of loop bodies in parallel without any significant overhead.

In the simplest embodiment of the present invention, the number of tasks that need to be running simultaneously for optimal use of the hardware, is in the region of the maximum overall latency, divided by the clock speed.

For example, a system connected to memories with a 20 ns access time or a 20 ns latency, but in which the processor runs at 10 GHz, would need 200 processes to use all hardware effectively. This number of concurrent processes is uncommon.

Another method of scheduling is to consider the average time between forks of a process, in clock cycles, and to schedule this number of operations per task or a number related thereto. For example, in the case of machine code compiled from a source written in the C++ language, the average number of C instructions between forks is typically 8 to 12. Each of these assembly instructions from which the machine code is derived, comprises a number of steps in microcode.

The number of steps depends on the architecture, but in the case of the present invention, the number will tend to be high because of the desire to have as much pipelining of the hardware as possible. Consider the case where the minimum machine instruction requires 8 micro instructions, typically 16, and the minimum case between test and branch instructions involves 20 micro instructions. In this case, at least 20 operations can be scheduled for each task within the pipe. If priority must be given to a dominant task, then 8 assembly level instructions could be run in the main pipe at any time, which is 96 microinstructions or pipe stages. This means that in the case where some tasks must dominate, they can occupy a larger proportion of the total pipe than for less important tasks.

Although the preferred embodiment only has been described in detail, it should be understood that various changes, substitutions and alterations can be made therein without departing from the spirit and scope of the invention as defined by the appended claims.

We claim:

1. A processing system for performing a plurality of tasks comprising at least one task, each task comprising a sequence of operations, the system comprising
a conveyor of pipe stages, wherein at least one pipe stage is used to define the current task status, the conveyor having a certain width comprising different fields including commands and operands; and
a clock signal generator;
wherein each pipe stage is assigned a time slot for performing each task of the plurality, whereby each pipe stage performs a certain operation of the sequence of operations for each task in the respective time slot assigned to said task, enabling continuous processing of every task of the plurality of tasks.

2. A processing system according to claim 1, wherein the total number of tasks being processed exceeds the longest latency within the system.

3. A processing system according to claim 1, wherein the number of pipe stages in each field of the conveyor width is equalized.

4. A processing system according to claim 3, comprising a pipeline for equalizing latency between different pipe stages.

5. A processing system according to claim 4, wherein the time slot is equal to one clock cycle, so that on each clock cycle each task flows from one stage to another stage.

6. A processing system according to claim 1, wherein the data rate on each pipe stage is not less than the system clock rate.

7. A processing system according to claim 1, wherein the processor is split onto a plurality of separate chips.

8. A processing system according to claim 1, further comprising an external memory.

9. A processing system according to claim 8, comprising a plurality of chips each splitted into a plurality of memory banks of the external memory, each memory bank being capable of performing operations independently from the other bank.

10. A processing system according to claim 9, wherein the amount of memory banks in the external memory is not less than the maximum memory operation period divided by a system clock period.

11. A processing system according to claim 8, wherein data processing is performed under operands residing in the external memory, whereby the amount of silicon is reduced by reducing the width of all the pipe stages and keeping all operands in the memory.

12. A processing system according to claim 8, wherein the value of the access time of the external memory in clock cycles should not exceed the number of pipe stages minus number of clock cycles required by processor core to perform operation.

13. A processing system according to claim 8, wherein the external memory performs one read and/or write operation per clock cycle with independent order of addresses or operations in the absence of data burst functions.

14. A processing system according to claim 1, wherein the processing system is a network processor.

15. A processing system according to claim 1, wherein the processing system is a digital processing system.

16. A processing system according to claim 1, wherein as many pipe stages is added as required to keep the amount of logic between two stages such that a signal propagation time is maintained across the logic to be less than the cycle period minus setup/hold time for each stage minus clock-to-output delay for the previous stage and minus interconnect delays between this logic and the surrounding pipe stages, thereby the clock period for the conveyor is minimised.

17. A method of data processing for performing a plurality of tasks comprising at least one task, each task comprising a sequence of operations, the method comprising
providing a conveyor of pipe stages, the conveyor having certain width comprising different fields including commands and operands, at least one pipe stage being used to define the current task status;
providing a clock signal;
wherein each pipe stage is assigned a time slot for performing each task of the plurality, whereby each pipe stage performs a certain operation of the sequence of operations for each task in the respective time slot assigned to said task, enabling continuous processing of every task of the plurality of tasks.

18. A method according to claim 17, wherein at every clock period a plurality of parallel actions is performed, one action by each stage of the conveyor.

19. A method according to claim 17, wherein the number of pipe stages in each field of the conveyor width is equalized.

20. A method according to claim 17, wherein the data rate on each pipe stage is not less than the system clock rate.

21. A method according to claim 17, wherein each task is performed substantially independent from the other task.

22. A method according to claim 17, wherein data processing is at least partially performed using the external memory.

23. A method according to claim 22, wherein data processing is performed under operands residing in the external memory.

24. A method according to claim 22, wherein the value of the access time of the external memory in clock cycles does not exceed the number of pipe stages minus number of clock cycles required by processor core to perform operation.

25. A method according to claim 17, wherein branches of implemented logical functions are kept at the same latency when applied to the next logical element in the pipe.

26. Random access memory device for storing data retrievable on a request, the memory device comprising:
a plurality of pipe stages forming a conveyor, wherein each pipe stage is assigned a time slot for processing each request of a plurality of requests, the conveyor being synchronised by a clock signal so that one request is processed by each pipe stage per clock cycle, and
logics for implementing address decorders, data selectors and fan-outs of signals within the memory;
wherein the amount of the logics is minimised by adding as many pipe stages as required to keep the amount of logic between two stages such that a signal propagation time is maintained across the logic to be substantially about or less than the cycle period minus setup/hold time for each stage minus clock-to-output delay for the previous stage and minus interconnect delays between this logic and the surrounding pipe stages.

27. Random access memory device according to claim 26, wherein address decoders comprises extra clock enable function on flip-flops preventing from address propagation onto not selected block.

28. Random access memory device according to claim 26, wherein the amount of logic between flip-flops is limited to 1 logic gates and limited number of loads connected to the output of each logic gate or flip-flop.

29. Random access memory device for storing data, comprising
a plurality of at least one memory region or bank for serving different tasks to provide a conveyor processing of operations from different tasks, wherein each region or bank and each group of tasks are assigned to each other such that each task of the group of tasks addresses a particular bank assigned to it; and
an internal addressing device for addressing the regions or banks by forwarding requests in a predetermined sequence to different memory regions or banks within the memory device, whereby external addressing of the region or bank is avoided.

30. Random access memory device according to claim 29, wherein the number of regions or banks is an integral multiple of the number of tasks.
